(19) United States
(12) Patent Application Publication
(10) Pub. No.: US 2008/0061948 A1
(43) Pub. Date: Mar. 13, 2008

(54) System and method for communicating with gate operators via a power line

(75) Inventor: Daniel Perez, Foothill Ranch, CA (US)

Correspondence Address: JAFARI LAW GROUP, P.C., 801 N. PARKCENTER DRIVE, SUITE 220, SANTA ANA, CA, 92705, US

(73) Assignee: Daniel Perez

(21) Appl. No.: 11/506,583

(22) Filed: Aug. 18, 2006

(51) Int. Cl. G05B 11/01; G08B 1/08

(52) U.S. Cl. 340/310.11; 340/538.11; 340/5.7

(57) ABSTRACT

The invention is a system and method for communicating with and controlling gate operators via a power line that normally only supplies power to the gate operator. By introducing an electrical signal to the power line along a frequency not used for the purposes of supplying electricity, signals and commands can propagate through a local power grid, for example a house, without need for installing additional wiring or utilizing wireless devices.

### TECHNICAL FIELD OF THE INVENTION

This invention relates generally to gate operator communication and more particularly the ability to communicate with a gate operator through a power line delivering power to the gate operator.

### BACKGROUND OF THE INVENTION

In the gate operator industry, equipment is built and designed to control access to an area using a gate. Occasionally, this equipment requires the use of at least two machines that span a certain distance. Generally, relays and signals are used to send information to and from both machines. In order to achieve this communication, an installer of a gate operator needs to connect wires between machines. In some situations, the installer needs to cut grooves into concrete or pavement for wires to run between two machines, which can be expensive and could require an area to be blocked off for a period of time. In other situations, where a groove could not be cut, an installer may artificially lengthen a communication wire, which may diminish the quality of communication. In still other situations, a gate operator installer may attempt to splice spare wires to the original communication wire to achieve the appropriate length, which may be more vulnerable to issues such as oxidation in the junctions, breakage, or intermittent false contacts.

Not only did the requirement of communication between physically distant machines create extra wiring that needed to be protected from the elements or vehicle wheels, but wires would oftentimes run parallel to power lines. The magnetic and electric fields emitted from the power lines created noise which interfered with the signals that were transmitting between the machines. If an installer is not able to use separate conduits for supplying power and for supplying communication signals, the low voltage wires running in parallel could cause noise so severe that communication signals could be corrupted to become a different signal, or communication signals could be completely blocked or erased.

Once a gate operator is installed, the gate operator may require special attention from the installer. In some instances the installer may be required to kneel down, adjust the necessary parameters, stand up, walk, verify functionality and repeat such steps as required in order to fine tune the parameters. During such testing, the installer would usually have to travel back and forth from the control board to the edge of the gate, all while the gate is in motion. Sometimes, all of this effort would result in only setting up one parameter. An installer may eliminate the need to walk back and forth between the control board and the gate by bringing a second installer to help aid in the process of setting-up the gate operator. However this means more personnel, and usually, more money for just a simple installation.

Considering that gate operators often work in tandem, sometimes more than one gate operator requires priming. The installer may encounter a situation during the setup of the second gate operator where the installer is required to change the setup of the first gate operator that has already been set-up and covered. The installer would then need to remove the cover of the first gate operator and setup the first gate operator again. The frequent need to remove the cover of each gate operator in order to complete or fine tune the setup of the gate operators may result in an inefficient use of time and money.

Once gate operators are installed, diagnostic tests are usually run from time to time by the installer or service provider in order to ensure that the gate operator is functioning properly. In the past the need for a diagnostic test for a particular event or situation would, again require the installer to remove the cover of the gate operator, in order to have access to the control board and troubleshoot the operation. Some manufactures have offered diagnostic ports or terminals that plug directly into the gate operator, yet these devices still require the installer or a technician to directly access the port and connect the device to aid in the diagnostic process.

For these reasons and others, the prior art has been inadequate to suit the needs of gate operator users, installers and manufacturers.

### SUMMARY OF THE INVENTION

To minimize the limitations found in the prior art, and to minimize other limitations that will be apparent upon the reading of the specification, the present invention provides a system and method for equipping and utilizing a gate operator with Power Line Communication (PLC) capabilities.

A system in accordance with the present invention comprises a power line for providing power, a first communication unit, connected to said power line, wherein said first communication unit is configured to inject a first set of data into said power line, and a second communication unit, connected to said power line, comprising a gate operator, wherein said second communication unit is configured to receive said first set of data from said power line.

A method in accordance with the present invention comprises injecting a first set of data into a power line from a first device, wherein said power line is attached to said first device for the purpose of providing power to said first device, and receiving said first set of data from said power line by a second device, comprising a gate operator, wherein said power line is attached to said second device for the purpose of providing power to said second device

It is one object of the invention to provide installers and manufacturers with a means to create and install a gate operator system without the need to trench extra conduits for communication.

It is another object of the invention to eliminate the need for communication wires between components of a gate operator system.

It is another object of the invention to minimize the need for service calls to manufacturers.

These and other advantages and features of the present invention are described with specificity so as to make the present invention understandable to one of ordinary skill in the art.

### BRIEF DESCRIPTION OF THE DRAWINGS

FIG. 1 illustrates a diagram of the basic physical connection of gate operators in accordance with various embodiments of the invention.

FIG. 2 is a block diagram schematic of an embodiment of one gate operator.

FIG. 3 illustrates an example of how to send signals over a power line.

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of these various elements and embodiments of the invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the invention.

In the following detailed description, a gate operator can be any system that controls a barrier to an entry, an exit, or a view. The barrier could be a door for a small entity, or a gate for a large entity (i.e. a vehicle), which can swing out, slide open, or even roll upwards. The operator which moves the barrier from an open position to a closed position and vice-versa can be manual or automatic.

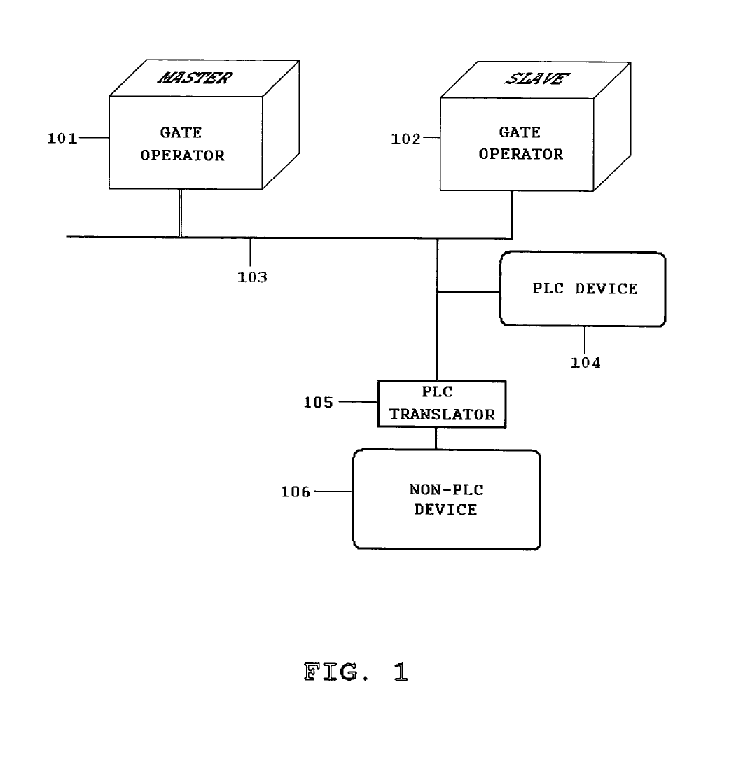

FIG. 1 illustrates a diagram of the basic physical connection of gate operators in accordance with various embodiments of the invention. Master gate operator 101 and slave gate operator 102 plug into power line 103 such that master gate operator 101 can communicate with slave gate operator 102 via power line 103. Master gate operator 101 and slave gate operator 102 can also derive power from power line 103. Using power line 103 as a vehicle to deliver power and signals, master gate operator 101 has the ability to synchronize with, and send commands to, receive commands from, or send and receive signals with, slave gate operator 102. Communication between master gate operator 101 and slave gate operator 102 can be mono-directional or bi-directional.

Typically master gate operator 101 will communicate with slave gate operator 102 to synchronize operation of a set of gates or barriers blocking a passageway. In one embodiment, master gate operator 101 and slave gate operator 102 are in constant communication with each other as they open or close to ensure an aesthetic, smooth, and synchronized operation where both gates move at the same rate and are the same distance away from a center spot. For example, the synchronization process could ensure that one gate slows down if it is pushed by a person, or by a gust of wind, or that the other gate speeds up. In another example, where two gates overlap each other, one gate could constantly communicate its relative position to the other gate so as to prevent a collision with each other, since one gate has to reach the close position prior than the other. While FIG. 1 illustrates a gate controlled by two devices, master gate operator 101 and slave gate operator 102, a gate may be controlled by more than two devices, or just a single master gate operator 101 without need of a slave gate operator 102.

Master gate operator 101 and slave gate operator 102 may also communicate with a number of access devices that are normally used in the access control industry through power line 103. These access control devices could be pre-configured to send signals along power line 103, such as PLC device 104, or a device which normally sends or receives signals along other connection channels, such as non-PLC device 106. In the latter instance, non-PLC device 106 can be connected to a PLC translator 105 so as not to require additional wiring or other devices.

PLC translator 105 provides a means of connection for access control of devices without PLC capabilities, and/or can provide power to the access control device without PLC capabilities. For instance, PLC translator 105 can comprise a power outlet for providing power, and a network cable interface for providing an input/output interface (not shown). In another embodiment, PLC translator 105 can perform functions on non-PLC device 106, such as resetting non-PLC device 106 in response to a command sent from master gate operator 101. In yet another embodiment, an entire gate operator system which may have originally necessitated communication wires, is installed with multiple PLC translators to enable the gate operator system to communicate via a power line.

PLC device 104 and non-PLC device 106 can be an input device that sends signals to any master gate operator 101, can be an output device that receives signals from any master gate operator 101, or can be an input/output device that utilizes bidirectional communication with any master gate operator 101. Signals can be propagated from master gate operator 101 to slave gate operator 102, or signals can be sent, received, or sent and received to both master gate operator 101 and slave gate operator 102. In another embodiment, master gate operator 101 only receives input, and acts as a slave gate operator to a device connected to power line 103.

Depending on the embodiment, PLC device 104 and non-PLC device 106 can be a wide variety of modules that connect with a gate operator via power line 103. For example, and in no way limiting the scope of the invention, PLC device 104 or non-PLC device 106 can be:

A button or a coded keypad that, when activated, sends a signal to a gate operator to activate a gate.

A sensor that monitors output signals from a gate operator and reacts to such information, such as displaying statistical information on an output interface, activating a light when the ambient light dims, informing a user of a major status change, or any other method commonly known to persons of ordinary skill in the art.

A control device that will change a status of a gate operator, or another device, such as opening a gate, closing a gate, stopping a gate, reversing a direction of a gate, activating an alarm system for a gate, activating a magnetic lock for a gate, setting a break for a gate, shutting down a gate, powering up a gate, setting a time delay to hold a gate open, setting an overlap timer between two gates, deactivating an inductive loop that normally detects a vehicle in the loop area, setting a code for a coded keypad, setting a time and date, setting a period of time gate is operational, setting an access code, or other status changes commonly known to persons of ordinary skill in the art.

A maintenance device which can perform monitoring, testing, diagnosing, setting, troubleshooting, modifying functionality (i.e. upgrading firmware/software), or perform other maintenance functions commonly known to persons of ordinary skill in the art.

A module which detects objects in the vicinity, such as an inductive loop, an infrared monitor, a video camera, a motion sensor, or other detecting objects commonly known to persons of ordinary skill in the art.

A wireless module which detects signals from a wireless transceiver, such as a radio frequency gate opener, a photobeam gate opener, or other wireless gate openers commonly known to persons of ordinary skill in the art.

A computer system which controls many such gate openers from a single point, or multiple points in a power grid. In one embodiment, a building's fire alarm system could send a command through the power grid to open all emergency doors in a building should the fire alarm be activated.

A separate gate operator, such as a barrier arm designed for an anti tail gating system. In one embodiment of such a system, this barrier arm opens shortly after master gate operator 101 and slave gate operator 102 have recently closed, allowing only one entity to exit/enter at a time.

Many other modules are possible and the above list is provided for illustration purposes only of different embodiments of PLC device 104 and non-PLC device 106. It is foreseeable that there are many opportunities to control, modify, and monitor master gate operator 101 and slave gate operator 102 through a common power grid using a power line to communicate signals between gate operator modules.

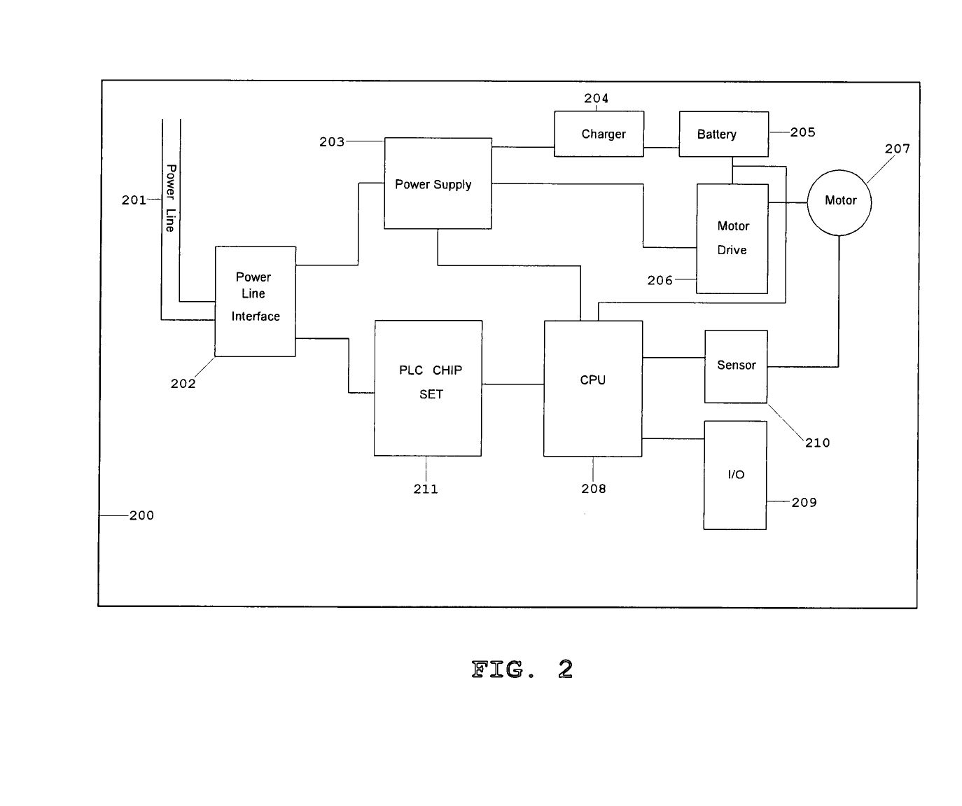

FIG. 2 is a block diagram schematic of an embodiment of one gate operator. Gate operator 200 can derive power, receive communication signals, and send communication signals through power line 201. Typically, a power line interface 202 can split a current (not shown) towards a power component and a signal component. In the illustration, power supply 203 draws power from power line interface 202, and feeds it to components of gate operator 200 which needs power, in this case battery charger 204, motor drive 206, and CPU 208. Through power line interface 202, PLC circuitry 211 can receive signals sent over power line 201 and send a decoded signal to CPU 208, can encode signals sent from CPU 208 and inject encoded signals into power line 201, or can do both. Those with skill in the art can make a variety of modifications, additions, and combinations to gate operator 200 to utilize power line 201 to provide power and a communication interface without departing from the scope of the present invention.

Battery charger 204 draws power from power supply 203, and uses that power to charge battery 205. Battery 205 can serve as a back-up device, and may provide power to both a motor drive 206 and CPU 208 should power become unavailable from power supply 203. Generally, however, CPU 208 and motor drive 206 are powered by power supply 203. Motor drive 206 controls motor 207, and can receive and respond to commands from CPU 208. Motor 207 in turn, is monitored by a sensor 210. Alternate embodiments of drawing power from power line 201 in a gate opener system can be used without departing from the scope of the present invention. For example, motor drive 206 and motor 207 could comprise the same device, and battery 205 could be eliminated.

CPU 208 controls the actions of gate operator 200 by communicating with motor drive 206, input/output device 209, sensor 210, and PLC circuitry 211. CPU 208 can receive commands sent through power line 201, decoded by PLC circuitry 211, and propagate those commands to other components of gate operator 200. For example, an open command can be sent through power line 201 to be propagated to motor drive 206 to open a gate.

In an exemplary embodiment, CPU 208 receives commands sent from input/output device 209, and propagates these commands to other components of gate operator 200. For example, and in no way limiting the scope of the present invention a command may be sent from input/output device 209 to monitor the speed of motor 207 via sensor 210, and display a speed at which a gate is moving or was moving.

In another embodiment, CPU 208 receives signals from motor drive 206, input/output device 209, sensor 210 and PLC circuitry 211, and sends signals to components of gate operator 200 based on an algorithm or program. For example, and in no way limiting the scope of the present invention, PLC circuitry 211 could receive a signal from power line 201 that a master gate operator had opened a primary gate, send a signal to motor drive 206 to open a secondary gate 2 seconds later, and send a signal to input/output device 209 to display the word “OPENING” on an output screen.

In yet another exemplary embodiment, program settings for CPU 208 can be set and reset through input/output device 209 on a signal through power line 201. For example, and in no way limiting the scope of the present invention, firmware could be updated through a physical port located on input/output device 209, and a gate opening time delay could be set by a master gate operator sending a signal through power line 201.

PLC circuitry 211 acts as a translating device to convert digital signals to and from CPU 208 into communication signals which can be injected into power line 201. When CPU 208 wishes to send or propagate a signal into power line 201, it first sends this signal to PLC circuitry 211, which encodes it into, for example, a frequency-shift key analog signal, and injects this signal into power line 201. When another device wishes to send a signal to gate opener 200, this signal is decoded by PLC circuitry 211, and is sent to CPU 208 for processing. Although PLC circuitry 211 and CPU 208 is shown here as two separate devices, they could be built as one device or several devices without departing the scope of the present invention.

There is more than one method to send communication signals over a power line. Frequencies and encoding schemes greatly influence both efficiency and speed of a signal sent over a power line. Various encoding schemes can be used to send data along power lines. Many techniques impose digital information over the electrical power flowing through the wiring of a house or a building.

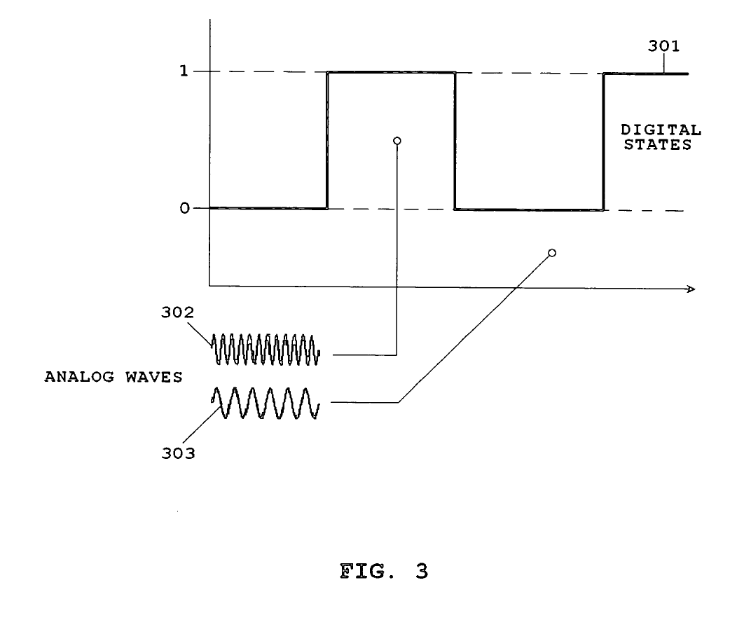

FIG. 3 illustrates an example of how to send signals over a power line. One method to send a signal over a power line is frequency-shift keying (FSK). FSK is a form of frequency modulation in which the modulating signal shifts the output frequency between predetermined values-in this illustration, the two values 0 and 1. A digital signal 301 also consists of two binary states: logic 0 and logic 1. These logic states are converted into carrier waves in the form of analog signal 302 and analog signal 303. In the illustrated embodiment, an analog signal for logic 1 is given a higher frequency 302 than the analog signal for logic 0 at frequency 303. These signals can be injected into a power line in a band of frequencies not used for the purpose of supplying electricity or managing electricity. Typically, a device that utilizes such analog signals will use low baud rates for simple data communication over long distances, and will use high baud rates for complex communication over short distances. A listening device on the power line can then demodulate analog signals to read the original digital signal that was sent.

FIG. 3 serves only as an explanation of FSK and does not limit any other types of encoding schemes that may also be used to send digital signals over power lines from being implemented with this invention. Other types of modulation may include but are not limited to: orthogonal frequency-division multiplexing, phase-shift keying, amplitude-shift keying and multiple frequency-shift keying.

Devices may be plugged into regular power outlets in a grid, or permanently wired in place via a common power source. Since carrier signals along a power line may propagate to other pieces of property on the same grid, in an exemplary embodiment, each signal is differentiated. A signal may control one device, or may control many devices in a common class of devices. In one embodiment, signals meant for one gate opening system are transmitted on specific frequencies to differentiate themselves. In another embodiment, signals meant for one gate opening system are prefixed or postfixed with a unique identifier, such as a “house address,”_0 which differentiates them from other signals. In yet another embodiment each device is characterized by a unique identifier or a digital signature to differentiate signals that are meant to be received by it. In an exemplary embodiment, each signal contains a frame that identifies which device sent the signal, which device should receive the signal, a signal, and a checksum.

Typically, once a device powers on, it will poll existing devices for their unique identifier, and will inform the other devices of its own. Commands can be sent mono-directionally from one device to another. In an exemplary embodiment, once a command is received, the receiving device sends an acknowledgment to the sending device. If an acknowledgment is not received by the sending device, the sending device can re-send a command until an acknowledgment is received, or a threshold has been reached, for example a certain amount of time has passed or the signal was sent a certain number of times.

For example and in no way limiting the scope of the invention, some types of commands that may be exchanged between gate operating devices over a power line could be to open a gate, to stop movement of a gate, to close a gate, to reverse movement of a gate, to reset, to activate an alarm, to deactivate an alarm, to power on, to power off, to set a timer delay, to set an overlap delay, read voltage, read a backup battery voltage, read a charging voltage, read an instantaneous motor current, read an instantaneous motor voltage, read a status of all inputs, read a status of all outputs, read a time delay, read an overlap delay, set a code for a keypad, set a master code momentary command, set a master code toggle command, set a time, set a date, send entry codes, set time for operation, read firmware version, and update firmware.

What is claimed is:

1. A system, comprising:
a power line for providing power;
a first communication unit, connected to said power line, wherein said first communication unit is configured to inject a first set of data into said power line; and
a second communication unit, connected to said power line, comprising a gate operator, wherein said second communication unit is configured to receive said first set of data from said power line.

2. The system of claim 1, wherein:
said first communication unit is configured to receive power from said power line;
said first communication unit is configured to inject said first set of data into said power line in a band of frequencies not used for the purposes of supplying electricity;
said second communication unit is configured to receive power from said power line; and
said second communication unit is configured to receive said first set of data in said band of frequencies.

3. The system of claim 2, wherein said first set of data comprises digital data, said first communication unit comprises a first apparatus to convert said digital data into analog data for sending digital signals along said power line, and said second communication unit comprises a second apparatus to convert said analog data back to said digital data for receiving digital signals along said power line.

4. The system of claim 3, wherein a portion of said digital data is a digital signature which uniquely identifies said second communication unit as a designated receiver of said data.

5. The system of claim 4, wherein a portion of said digital data is a digital signature which uniquely identifies said first communication unit as a sender of said data.

6. The system of claim 5, wherein said first apparatus is configured to convert said digital data into said analog data, and said second apparatus is configured to convert said analog data into said digital data.

7. The system of claim 6, wherein said first apparatus configured to convert said digital data into analog data uses frequency shift keying modulation, and said second apparatus configured to convert said analog data into said digital data uses frequency shift keying demodulation.

8. The system of claim 6, wherein said first apparatus configured to convert said digital data into analog data uses using phase-shift keying modulation and said second apparatus configured to convert said analog data into said digital data uses using phase-shift keying demodulation.

9. The system of claim 6, wherein said first apparatus configured to convert said digital data into analog data uses orthogonal frequency-division multiplexing modulation and said second apparatus configured to convert said analog data into said digital data uses orthogonal frequency-division multiplexing demodulation.

10. The system of claim 6, wherein said first apparatus configured to convert said digital data into analog data uses amplitude-shift keying modulation and said second apparatus configured to convert said analog data into said digital data uses amplitude-shift keying demodulation.

11. The system of claim 1, wherein said second communication unit is configured to change to a status upon receipt of said first set of data received from said power line.

12. The system of claim 11, wherein said change to said status comprises controlling said gate operator.

13. The system of claim 12, wherein said first communication unit comprises a second gate operator.

14. The system of claim 11, wherein said first communication unit comprises:
a control device configured to generate said first set of data and not configured to inject said first set of data into said power line;
and a translator device configured to inject said first set of data into said power line.

15. The system of claim 11, wherein said gate operator is configured to receive said first data and is not configured to receive said first set of data from said power line, and wherein said second communication unit further comprises a translator device configured to receive said first set of data from said power line and send said first set of data to said gate operator.

16. The system of claim 11, wherein said second communication unit is configured to inject a second set of data into said power line, and said first communication unit is configured to receive said second set of data from said power line, enabling bidirectional communication between said first communication unit and said second communication unit.

17. The system of claim 16, wherein said first communication device comprises a control unit device for performing maintenance functions on second communication device.

18. The system of claim 17, wherein said maintenance functions comprises programming said second communication device.

19. The system of claim 17, wherein said maintenance functions comprises diagnosing said second communication device

20. The system of claim 17, wherein said maintenance functions comprises setting a parameter of said second communication device.

21. The system of claim 17, wherein said maintenance functions comprises changing a functionality of said second communication device.

22. A system, comprising:
a power line for providing power;
a first communication unit, connected to said power line, comprising a gate operator, wherein said first communication unit is configured to inject a first set of data into said power line; and
a second communication unit, connected to said power line, wherein said second communication unit is configured to receive said first set of data from said power line.

23. The system of claim 22, wherein said second communication unit is configured to change to a status upon receipt of said first set of data received from said power line.

24. The system of claim 23, wherein said change of status comprises outputting a portion of said first set of data to an output interface.

25. The system of claim 23, wherein said second communication unit comprises:
an apparatus configured to change to said status upon receipt of said first set of data and not configured to receive said first set of data from said power line;
and a translator device configured to receive said first set of data into said power line and send said first set of data to said apparatus.

26. The system of claim 22, wherein said second communication unit is configured to inject a second set of data into said power line, and said first communication unit is configured to receive said second set of data from said power line, enabling bidirectional communication between said first communication unit and said second communication unit.

27. A method for controlling devices in a gate operator system, comprising:
injecting a first set of data into a power line from a first device, wherein said power line is attached to said first device for the purpose of providing power to said first device; and
receiving said first set of data from said power line by a second device, comprising a gate operator, wherein said power line is attached to said second device for the purpose of providing power to said second device.

28. The method of claim 27, wherein said first device comprises a first gate operator, and said second device comprises a second gate operator, further comprising:
changing a state of said second gate operator from said first device with said first set of data.

29. The method of claim 27, wherein changing a state of said second gate operator is selected from a group consisting of:
opening a gate;
closing a gate;
halting movement of a gate;
reversing movement of a gate;
altering a moving speed of a gate;
activating an alarm system of a gate; and
delaying a movement of a gate.

30. The method of claim 27, wherein:
injecting said first set of data into said power line comprises sending said first set of data in a band of frequencies not used for the purposes of supplying electricity; and
receiving said first set of data into said power line comprises receiving said first set of data in a band of frequencies not used for the purposes of supplying electricity.

31. The method of claim 30, wherein:
injecting said first set of data into said power line further comprises encoding a digital signal of said first set of data into an analog signal of said first set of data; and
receiving said first set of data into said power line further comprises decoding an analog signal of said first set of data to a digital signal of said first set of data.

32. The method of claim 31, further comprising:
injecting said first set of data into said power line further comprises sending a digital signature that uniquely identifies said second device; and
receiving said first set of data into said power line further comprises verifying that said first set of data contains a digital signature that uniquely identifies said second device.

33. The method of claim 27, further comprising:
sending commands to control said gate operator using said first set of data.

34. The method of claim 27, further comprising:
injecting a second set of data into a power line from said second device; and
receiving said second set of data from said power line by said first device, enabling bi-directional communication between said first device and said second device.

35. The method of claim 34, further comprising:
performing maintenance functions on said gate operator utilizing data sent through said power line.
